(19) United States
(12) Patent Application Publication
(10) Pub. No.: US 2013/0330458 A1
(43) Pub. Date: Dec. 12, 2013

(54) No-Calorie Sweetener Compositions

(71) Applicant: TC Heartland LLC, Carmel, IN (US)

(72) Inventor: Ted Gelov, Carmel, IN (US)

(21) Appl. No.: 13/965,955

(22) Filed: Aug. 13, 2013

Related U.S. Application Data
(63) Continuation of application No. 12/510,869, filed on Jul. 28, 2009, now abandoned.

(51) Int. Cl. A23L 1/236

(52) U.S. Cl. CPC A23L 1/2364
USPC 426/548

(57) ABSTRACT

The invention provides no-calorie or low calorie sweetener compositions comprising a sugar alcohol, sucralose, and a carbohydrate carrier.

### BACKGROUND OF THE INVENTION

The invention relates to “no calorie” sweetener compositions, which are suitable for use as a table sugar substitute and/or in the preparation of baked foods, and other prepared liquid, solid and semisolid comestibles and food stuffs.

People crave sweet foods and drinks, however, natural sweeteners, such as sugar, have a high caloric content and lead to weight gain when consumed in large amounts. Moreover, people with certain medical conditions, such as various forms of diabetes, must severely limit their sugar intake. In order to overcome these problems, researchers have been looking for sweetener compositions with very low or no caloric content, that are sweet but otherwise have a neutral taste and can be readily used in food stuff.

Intense sweetening agents are natural or synthetic compounds, which have a sweetening intensity greater than sugar and which typically have a caloric value lower than sugar. Examples of intense sweetening agents include saccharin, cyclamate, acesulfame-K, proteins such as thaumatin, chlorodeoxysugar derivatives (e.g., sucralose), aspartame, alitame, and the like. Because intense sweeteners provide greater sweetening capacity than sugar, smaller amounts of intense sweeteners will provide sweetening intensity equivalent to larger amounts of sugar. Accordingly, intense sweeteners are widely used in place of sugar in many low calorie compositions. Intense sweeteners can provide compositions that have decreased caloric value as compared to sugar-sweetened compositions because far lower amounts of the intense sweetener are required to achieve optimum sweetness in the composition.

Intense sweetening agents have been blended or admixed with bulking agents to form a so-called bulked sweetener compositions. For example, Equal® Granular 0 Calorie Sweetener contains aspartame in combination with dextrose and maltodextrin. Sweet'N Low® Sugar Substitute contains saccharin in combination with dextrose and maltodextrin. Similarly Splenda® No Calorie Sweetener contains sucralose in combination with dextrose and maltodextrin. Intense sweetening agents have alternatively been blended with sugar alcohols or polyols such as erythritol, isomalt, lactitol, maltitol, mannitol, sorbitol, and xylitol. Most polyols are incompletely digested and poorly absorbed and so have caloric values that are lower than that of sugar.

Despite the wide variety of natural and synthetic sugar substitutes available, consumers complain that such artificial sweeteners do not have the same sweetness as sugar, have an undesirable aftertaste, and/or do not have the same look (e.g., texture) and feel (e.g., mouthfeel) as sugar. In addition, consumers have found that such artificial sweeteners cannot readily be used in baking applications due to problems with temperature instability, undesirable aftertaste, and/or undesirable texture and structure of the resulting baked goods.

Thus, there remains a need in the art for a sweetener composition that is no calorie, has equivalent sweetness to sugar, and has the look, taste, and feel of sugar. In addition, there remains a need in the art for a sweetener composition that is no calorie, has equivalent volume to sugar such that it can be used as a sugar substitute in baking applications, and has the look, taste, texture, and flow properties of sugar.

BRIEF SUMMARY OF THE INVENTION

The invention provides a sweetener composition that is low-calorie or no-calorie and that substantially looks, tastes, bakes, and feels like sugar. The invention preferably is a low-calorie or no-calorie composition comprising, consisting essentially of, or consisting of a sugar alcohol, sucralose, and a carbohydrate carrier. In some embodiments, the sweetener composition is a bulk sweetener composition that is equal to sugar on a teaspoon to teaspoon and cup to cup basis and which can be used as a 1:1 volume baking substitute for sugar. In other embodiments, the sweetener composition is a tabletop sweetener composition, which can be placed in packets to be used as equivalent to two teaspoons of sugar. Desirably the sweetener composition contains between about 55 wt. % and about 85 wt. % xylitol.

The invention further provides a low-calorie or no-calorie sweetener composition consisting essentially of xylitol, sucralose, and maltodextrin, wherein the sucralose is affixed to the maltodextrin. Desirably the sweetener composition of this embodiment has a finished product bulk density of about 0.2 g/ml to about 0.4 g/ml (e.g., about 0.3 g/ml). In a preferred embodiment, the invention provides a sweetener composition consisting essentially of about 55 wt. % to about 78 wt. % xylitol, about 0.01 wt. % to about 1 wt. % sucralose, and about 20 wt. % to about 40 wt. % maltodextrin, wherein the sucralose is affixed to the maltodextrin. In an alternate embodiment, the invention provides a sweetener composition consisting essentially of about 55 wt. % to about 78 wt. % xylitol, about 0.01 wt. % to about 1 wt. % sucralose, and about 20 wt. % to about 40 wt. % maltodextrin, wherein the sucralose is affixed to the xylitol. In another preferred embodiment, the invention provides a sweetener composition consisting essentially of about 70 wt. % xylitol, about 0.275 wt. % sucralose, and about 29.725 wt. % maltodextrin, wherein the composition is granular.

The invention yet further provides a low-calorie or no-calorie sweetener composition consisting essentially of a free flowing dry blend of about 75 to about 85 wt. % xylitol, about 0.05 to about 1.5 wt. % sucralose, and about 15 to about 25 wt. % agglomerated dextrose consisting of dextrose monohydrate and maltodextrin, wherein the sweetener composition has greater than 0.5 calories per gram of sucrose equivalent sweetness. In a preferred embodiment, the invention provides a sweetener composition consisting essentially of a free flowing dry blend of about 80 wt. % xylitol, about 0.65 wt. % sucralose, and about 19.35 wt. % agglomerated dextrose consisting of dextrose monohydrate and maltodextrin.

### DETAILED DESCRIPTION OF THE INVENTION

The invention is directed to a low-calorie or no-calorie sweetener composition comprising a sugar alcohol in combination with sucralose and a carbohydrate carrier. In some embodiments, the sweetener composition consists essentially of a sugar alcohol (e.g., xylitol), sucralose, and a carrier selected from the group consisting of maltodextrin, dextrose, and combinations thereof. In other embodiments, the sweetener composition consists of a sugar alcohol (e.g., xylitol), sucralose, and a carrier selected from the group consisting of maltodextrin, dextrose, and combinations thereof.

In some embodiments, the sweetener composition is a bulk sweetener composition, which can be used as a 1:1 volume baking substitute for sugar. In such embodiments, about 1.5 grams of the sweetener composition desirably has equivalent sweetness to about 1 teaspoon (or about 4 grams) of sugar. In other embodiments, the sweetener composition is a tabletop sweetener composition suitable for use in single serving packets. In these embodiments, about 1.5 grams of the sweetener composition desirably has equivalent sweetness to about 2 teaspoons (or about 8 grams) of sugar. Desirably, the sweetener composition of these embodiments has a finished product bulk density of about 0.2 g/ml to about 0.4 g/ml, preferably about 0.25 g/ml to about 0.35 g/ml, or more preferably about 0.28 g/mol to about 0.32 g/ml (e.g., about 0.3 g/ml).

The sweetener composition desirably is a no-calorie composition. In accordance with the U.S. FDA's Guidance for Industry: A Food Labeling Guide, the term “no calorie” means that the food contains less than 5 calories per reference amount customarily consumed and per labeled serving. The serving size can be any suitable amount, but typically is between about 1 and about 4 grams. Preferably the serving size is between about 1 gram and about 2 grams. In preferred embodiments, the sweetener composition contains less than 5 calories per 1.5 g.

The sweetener composition comprises sucralose (4,1′,6′-trichloro-4,1′,6′-trideoxygalactosugar), a sweetener with a sweetness intensity approximately 600 times that of sugar. Because sucralose is a high intensity sweetener, only a small amount of sucralose is needed. Typically the sweetener composition comprises about 0.01 wt. % to about 1.5 wt. % sucralose (e.g., about 0.1 wt. % to about 1 wt. %), based on the total weight of the composition. When the sweetener composition is a bulk sweetener composition, the sweetener composition preferably comprises about 0.01 wt. % to about 1 wt. %, about 0.1 wt. % to about 0.5 wt. % sucralose, or about 0.2 wt. % to about 0.3 wt. % sucralose, based on the total weight of the composition. When the sweetener composition is a packet sweetener composition, the sweetener composition preferably comprises about 0.05 wt. % to about 1.5 wt. % sucralose, about 0.1 wt. % to about 1 wt. % sucralose, or about 0.6 wt. % to about 0.7 wt. % sucralose, based on the total weight of the composition.

The sugar alcohol is a polyol derived from a carbohydrate whose carbonyl group (aldehyde or ketone) has been reduced to a primary or secondary hydroxyl group. Sugar alcohols can be classified by chemical structure as monosaccharide-derived, disaccharide-derived, or polysaccharide-derived mixtures. The sugar alcohol can be any suitable polyol, for example a polyol selected from the group consisting of sorbitol, mannitol, maltitol, erythritol, xylitol, lactitol, palatinit, and combinations thereof. Preferably the sugar alcohol is a monosaccharide-derived polyol selected from sorbitol, mannitol, xylitol, and erythritol. More preferably, the sugar alcohol is xylitol. In some embodiments, the sweetener composition comprises consists essentially of, or consists of, sucralose, xylitol, and the carbohydrate carrier.

The amount of sugar alcohol used in the sweetener composition can be any suitable amount. Typically, the amount of sugar alcohol is between about 50 wt. % to about 90 wt. %, preferably about 55 wt. % to about 85 wt. %, or about 60 wt. % to about 85 wt. %, based on the total weight of the composition. When the sweetener composition is a bulk sweetener composition, the sweetener composition preferably comprises about 55 wt. % to about 78 wt. % (e.g., about 65 to about 75 wt. % or about 68 to about 72 wt. %) sugar alcohol, based on the total weight of the composition. For example, preferred bulk sweetener compositions contain about 55 wt. % to about 78 wt. %, about 65 to about 75 wt. %, or about 68 to about 72 wt. % xylitol, based on the total weight of the composition. When the sweetener composition is a packet sweetener composition, the sweetener composition preferably comprises about 75 wt. % to about 85 wt. % or about 78 wt. % to about 82 wt. % sugar alcohol, based on the total weight of the composition. For example, preferred packet sweetener compositions contain about 75 wt. % to about 85 wt. % or, more preferably, about 78 wt. % to about 82 wt. % xylitol, based on the total weight of the composition.

The carrier is a carbohydrate carrier selected to provide bulk to dry mix compositions with minimum density. Typically the carrier is a carbohydrate carrier selected from the group consisting of maltodextrin, dextrose, and combinations thereof. In a preferred embodiment, the sucralose is affixed to (i.e., intimately associated with) and/or adhered to the carbohydrate carrier such as by spray drying. When the sweetener composition is a bulk sweetener composition, the sweetener composition preferably comprises maltodextrin (e.g., maltodextrin M700, which has a bulk density of about 0.13 g/cm³). When the sweetener composition is a packet sweetener composition, the sweetener composition preferably comprises dextrose or a combination of dextrose and maltodextrin, such as an agglomerated dextrose consisting of dextrose monohydrate and maltodextrin, sold as Unidex® (Corn Products U.S.).

The amount of carbohydrate carrier used in the no-calorie sweetener composition can be any suitable amount. Typically, the amount of carbohydrate carrier is about 10 wt. % to about 40 wt. %, e.g., about 15 wt. % to about 35 wt. %, or about 18 wt. % to about 32 wt. %, based on the total weight of the composition. When the sweetener composition is a bulk sweetener composition, the sweetener composition preferably comprises about 20 wt. % to about 40 wt. %, about 25 wt. % to about 35 wt. %, or about 28 wt. % to about 32 wt. % carbohydrate carrier (e.g., maltodextrin), based on the total weight of the composition. When the sweetener composition is a packet sweetener composition, the sweetener composition preferably comprises about 15 wt. % to about 25 wt. %, about 18 wt. % to about 22 wt. %, or about 19 wt. % to about 20 wt. % carbohydrate carrier (e.g., agglomerated dextrose consisting of dextrose monohydrate and maltodextrin), based on the total weight of the composition.

When the sweetener composition is a bulk sweetener composition, it is preferred that the sugar alcohol is xylitol and the carbohydrate carrier is maltodextrin. In addition, it is preferred that the sucralose be affixed to (i.e., intimately associated with) and/or adhered to the maltodextrin such as by spray drying. In an especially preferred bulk sweetener composition, the composition consists essentially of xylitol, sucralose, and maltodextrin, wherein the sucralose is affixed and/or adhered to the maltodextrin, more preferably by spray drying. Desirably the sucralose and maltodextrin are co-dissolved and spray dried to form flaky solid having bulk density of about 0.06 g/ml to about 0.1 g/ml (e.g., about 0.07 g/ml to about 0.09 g/ml). In addition, it is preferred that the finished product has density of about 0.2 g/ml to about 0.4 g/ml (e.g., about 0.25 g/ml to about 0.35 g/ml, or about 0.28 g/ml to about 0.32 g/ml). In another preferred bulk sweetener composition, the composition consists essentially of about 55 wt. % to about 78 wt. % xylitol, about 0.01 wt. % to about 1 wt. % sucralose, and about 20 wt. % to about 40 wt. % maltodextrin, based on the total weight of the composition, wherein the sucralose is affixed to and/or adhered to the maltodextrin. In yet another preferred bulk sweetener composition, the composition consists essentially of, or consists of, about 68 wt. % to about 72% xylitol, about 0.125 wt. % to about 0.29 wt. % sucralose, and about 29.5 wt. % to about 30 wt. % maltodextrin (e.g., about 70 wt. % xylitol, about 0.275 wt. % sucralose, and about 29.725 wt. % maltodextrin), based on the total weight of the composition. The bulk sweetener composition desirably is granular.

When the sweetener composition is a packet sweetener composition, it is preferred that the sugar alcohol is xylitol and the carbohydrate carrier is agglomerated dextrose consisting of a mixture of ˜97% dextrose monohydrate and ˜3% maltodextrin (e.g., Unidex®). In another preferred packet sweetener composition, the composition consists essentially of, or consists of, a free flowing dry blend of about 75 wt. % to about 85 wt. % xylitol, about 0.05 wt. % to about 1.5 wt. % sucralose, and about 15 wt. % to about 25 wt. % agglomerated dextrose consisting of dextrose monohydrate and maltodextrin, based on the total weight of the composition.

In some embodiments, the sweetener composition of the invention has greater than 0.5 calories per gram of Sucrose Equivalent Sweetness. Sucrose Equivalent Sweetness is defined as the amount of sucralose needed to be added to an 8 ounce glass of water in order to provide the same sweetness as an independent 8 ounce glass of water containing 1 gram of sucrose. Desirably the composition has less than 0.7 calories per gram of Sucrose Equivalent Sweetness (e.g., less than 0.6 calories per gram of Sucrose Equivalent Sweetness, or less than 0.55 calories per gram of Sucrose Equivalent Sweetness). In other embodiments, the sweetener composition of the invention has less than 0.5 calories per gram of Sucrose Equivalent Sweetness.

In yet another preferred packet sweetener composition, the composition consists essentially of, or consists of, a free flowing dry blend of about 79 wt. % to about 81% xylitol, about 0.6 wt. % to about 0.7 wt. % sucralose, and about 19 wt. % to about 20 wt. % agglomerated dextrose consisting of dextrose monohydrate and maltodextrin (e.g., about 80 wt. % xylitol, about 0.65 wt. % sucralose, and about 19.35 wt. % agglomerated dextrose consisting of dextrose monohydrate and maltodextrin), based on the total weight of the composition.

The foregoing compositions may be made by any suitable processes. In some embodiments, the no-calorie sweetener composition of the invention is prepared by dry blending, e.g., using a conventional paddle blender or twinshell V blender and/or other suitable blender, many of which are known in the art. In other embodiments, the no-calorie sweetener composition of the invention is prepared by spray drying the sucralose and the carbohydrate carrier (e.g., maltodextrin) together and then dry blending the resultant mixture with the sugar alcohol (e.g., xylitol). Suitable spray dryers include any conventional spray dryer, many of which are known in the art.

The following examples further illustrate the invention but, of course, should not be construed as in any way limiting its scope.

### EXAMPLE 1

This example illustrates no calorie sweetener compositions of the invention comprising xylitol, sucralose and a carbohydrate carrier.

In a first experiment, xylitol, sucralose, and agglomerated dextrose/maltodextrin (˜97%/˜3%) (Unidex®) were blended together in the amounts set forth in the table below to produce compositions 1A-1J.

| | xylitol | | sucralose | | Unidex ® | |
|---|---|---|---|---|---|---|
| Composition | g | (wt. %) | g | (wt. %) | g | (wt. %) |
| 1A | 1.5 | 100 | 0 | 0 | 0 | 0 |
| 1B | 1.35 | 90.0 | 0.0102 | 0.68 | 0.14 | 9.32 |
| 1C | 3.0 | 85.7 | 0.006 | 0.2 | 0.494 | 14.1 |
| 1D | 1.2 | 80.0 | 0.0104 | 0.69 | 0.29 | 19.31 |
| 1E | 4.0 | 80.0 | 0.012 | 0.2 | 0.988 | 19.8 |
| 1F | 3.0 | 75.0 | 0.012 | 0.3 | 0.988 | 24.7 |
| 1G | 1.05 | 70.0 | 0.0106 | 0.71 | 0.439 | 29.29 |
| 1H | 3.0 | 66.6 | 0.018 | 0.4 | 1.482 | 33.0 |
| 1I | 0.90 | 60.0 | 0.0109 | 0.73 | 0.589 | 39.27 |
| 1J | 0.75 | 50.0 | 0.0111 | 0.74 | 0.739 | 49.26 |

Each of the compositions 1A-1F was evaluated for taste, flow, and visible texture as compared to sugar. The results of these evaluations is set forth in the table below.

| Composition | Taste | Texture | Flow |
|---|---|---|---|
| 1A | oily | clumpy | poor |
| 1B | oily | clumpy | poor |
| 1C | good | sugar-like | good |
| 1D | great | sugar-like | good |
| 1E | great | sugar-like | good |
| 1F | great | sugar-like | good |
| 1G | great | sugar-like | good |
| 1H | great | sugar-like | good |
| 1I | good | powdery | good |
| 1J | good | powdery | great |

Each of compositions 1C-1J had good taste and flow properties. Moreover, compositions 1C-1H had a texture comparable to that of sugar. Compositions 1 A and 1B did not flow as well and had a clumpy texture that stuck to a spoon. In addition compositions 1A and 1B had a less desirably oily aftertaste. Compositions 1I and 1J had a less desirable texture that was more powdery than sugar and left a fine residue on surfaces.

In a second experiment, xylitol was blended with spray dried sucralose/maltodextrin having a density of 0.07-0.08 g/ml (prepared in accordance with Example 3) in the amounts set forth in the table below to produce compositions 1K-10.

| | | sucralose/ | | calories |
|---|---|---|---|---|
| | xylitol | maltodextrin | Density | per |
| Composition | (wt. %) | (wt. %) | (g/tsp) | serving |
| 1K | 90.0 | 10.0 | 3.2 | 8.06 |
| 1L | 80.0 | 20.0 | 2 | 5.28 |
| 1M | 70.0 | 30.0 | 1.5 | 4.14 |
| 1N | 60.0 | 40.0 | 1.2 | 3.46 |
| 1O | 50.0 | 50.0 | | |

Each of the compositions 1K-10 was evaluated for taste, flow, and visible texture as compared to sugar. The results of these evaluations is set forth in the table below.

| Composition | Taste | Texture | Flow |
|---|---|---|---|
| 1K | oily | clumpy | poor |
| 1L | great | sugar-like | good |
| 1M | great | sugar-like | good |
| 1N | good | powdery | good |
| 1O | good | very powdery | great |

Each of compositions 1L-1O had good taste and flow properties. Moreover, compositions 1L and 1M had a texture comparable to that of sugar. Composition 1K did not flow as well and had a clumpy texture that stuck to a spoon. In addition composition 1K had a less desirably oily aftertaste. Compositions 1N and 1O had a less desirable texture that was more powdery than sugar and left a fine residue on surfaces.

This example demonstrates that no calorie sweetener compositions of the invention comprising a sugar alcohol, sucralose and a carbohydrate carrier can be prepared having taste, texture, and flow properties close to those of sugar.

### EXAMPLE 2

This example illustrates a no calorie sweetener composition of the invention comprising xylitol that is suitable for tabletop use in packets.

Sucralose (2.95 kg, Nevella® R17009900) is distributed evenly over agglomerated dextrose (23 kg, Unidex® R1700910) previously charged to a paddle blender and the mixture is blended for 4 minutes on medium speed. An additional quantity of agglomerated dextrose (64.77 kg, Unidex® R1700910) is then added and the mixture is blended for 8 minutes on medium speed. Following the pre-mix blending stage, the blended mixture is transferred to a holding hopper. The sucralose-agglomerated dextrose premixture (90.72 kg) is divided evenly between the two blender shells of a twin shell “V” blender containing xylitol (130 kg) and the mixture is blended for 10 minutes on low speed. An additional quantity of xylitol (232.88 kg) is then divided evenly between the two blender shells and the mixture is blended for an additional 10 minutes at low speed.

This example demonstrates that a no calorie sweetener composition comprising a sugar alcohol, sucralose, and a carbohydrate carrier can be prepared which has a taste, texture and flow property close to that of sugar.

### EXAMPLE 3

This example illustrates a no calorie sweetener composition of the invention comprising xylitol that is volume equivalent to sugar (i.e., 1 teaspoon sweetener composition of the invention (˜1.5 g)=1 teaspoon of sugar (˜4 g)).

Maltodextrin M-100 (256.19 kg) and sucralose (3.11 kg, Nevella®) are added to 137 gallons of water in a stainless steel blending tank. The resulting mixture is heated to a temperature of 150° F. to 155° F. and blended for 20-30 minutes or until the mixture has a dissolved solid to water ratio between 50 and 55%. The solution containing the dissolved maltodextrin and sucralose solids is then pumped to the top of a spray dryer and carbon dioxide is injected into the transfer line so as to increase the volume prior to reaching the spray nozzle atomizer. The solution is then spray dried to produce a flaky solid having a bulk density between about 0.06 g/ml and about 0.1 g/ml UCL a moisture content between about 3% and about 5%.

A portion of the sucralose/maltodextrin spray dried mixture (90.765 kg) is blended with xylitol (423.57 kg) in a twin shell “V” blender for 4 minutes on low speed, and then a second portion of the sucralose/maltodextrin spray dried mixture (90.765 kg) is added and the mixture is blended for an additional 12 minutes on low speed. The resulting sweetener composition contains 70% xylitol, 29.725 wt. % maltodextrin M-700, and 0.275 wt. % sucralose, has a density ranging from 0.2 g/ml to 0.4 g/ml, preferably about 0.35 g/ml, and has a calorie content of 4.3 calories per teaspoon (˜1.5 g) of sweetener composition.

This example demonstrates that a no calorie sweetener composition comprising a sugar alcohol, sucralose, and a carbohydrate carrier can be prepared which is volume equivalent to sugar.

### EXAMPLE 4

This example compares the properties of a sweetener composition of the invention to other commercially available sweeteners. Specifically, this example compares the flavor, mouthfeel, sweetness level, overall likability, and intent to purchase of a sweetener composition of the invention consisting of 80 wt. % xylitol, 19.35 wt. % Unidex® blend of dextrose and maltodextrin, and 0.65 wt. % sucralose, to sugar (Comparison 4A), Splenda® sucralose sweetener (Comparison 4B), and Truvia® rebiana and erythritol blend sweetener (Comparison 4C).

The dry sweetener products used for comparison were received at the test site (Purdue University) the week prior to the test and were held at room temperature until testing. Panelists were solicited randomly and consisted primary of students and faculty of Purdue University. For Comparison 4A, each panelist was given two cups of ice cold 100 ml Lipton® Unsweetened Green Tea, 1.5 g of the sweetener composition of the invention, 4 g Domino Cane sugar, a cup of filtered water, a napkin and a stir stick. For Comparison 4B, each panelist was given 2 packets of the sweetener composition of the invention and an equivalent weight of Splenda® sucralose sweetener. For Comparison 4C, each panelist was given two packets of Truvia® rebiana and erythritol blend sweetener and an equivalent weight of the sweetener composition of the invention.

After receiving the samples, the panelist was asked to answer 9 point liking hedonic (9=Like extremely, 1=Dislike extremely) questions regarding overall liking, flavor and mouth-feel. Then the panelists were asked to answer a 5 point JAR (Just About Right) questions about sweetness levels (5=Much too Sweet, 1=Not Nearly Sweet Enough). Finally, the panelists were asked to indicate their intent to purchase (5=definitely would Purchase, 1=definitely would Not Purchase). The two samples were given to the panelist at the same time. The first sample was rotated to prevent first sample bias. The panelist was given water to rinse their palate between samples. When complete, the panelist received a $10 gift card and was able to select a piece of candy as a reward.

The results from the comparison studies (reported as the mean of each rating value) are set forth in the table below.

| | Comparison 4A | | | Comparison 4B | | | Comparison 4C | | |
|---|---|---|---|---|---|---|---|---|---|
| | | | p | | | p | | | p |
| | invention | sugar | value | invention | Splenda | value | invention | Truvia | value |
| flavor (1-9) | 6.60 | 5.78 | 0.0001 | 7.18 | 6.48 | 0.0032 | 7.18 | 6.48 | 0.0032 |
| mouthfeel (1-9) | 6.48 | 6.18 | 0.0219 | 6.77 | 6.47 | 0.1407 | 6.77 | 6.47 | 0.1407 |
| overall liking | 6.52 | 5.55 | 0.0000 | 7.12 | 6.37 | 0.0011 | 7.12 | 6.37 | 0.0011 |
| (1-9) | | | | | | | | | |
| sweetness level | 2.80 | 2.21 | 0.0000 | 3.41 | 3.22 | 0.0867 | 3.41 | 3.22 | 0.0867 |
| (1-5) | | | | | | | | | |
| intent to purchase | 2.95 | 2.38 | 0.0000 | 3.47 | 2.99 | 0.0030 | 3.47 | 2.99 | 0.0030 |
| (1-5) | | | | | | | | | |

The results of the three comparison studies demonstrate that the sweetener composition of the invention ranked surprisingly higher than sugar (Comparison 4A), Splenda® sucralose sweetener (Comparison 4B), and Truvia® rebiana and erythritol blend sweetener (Comparison 4C) for flavor, mouthfeel, overall liking, sweetness level, and intent to purchase.

### EXAMPLE 5

This example demonstrates the use of a no calorie sweetener composition of the invention in baking applications. Specifically, this example demonstrates the use of a sweetener composition of the invention in preparing a yellow cake.

A standard household wall oven was preheated to a temperature of 350° F. A cake pan was then greased and floured for preparation to accept the mixed batter for the cake. Five cake batter compositions (5A-5E) were prepared using a sweetener composition of the invention consisting of 70 wt. % xylitol, 29.725 wt. % maltodextrin, and 0.275 wt. % sucralose (5A), sugar (5B), Splenda® sucralose sweetener (5C), saccharin (5D) or aspartame (5E) in combination with the ingredients set forth in the table below. All weights are reported in grams.

| | 5A | | 5B | | 5C | | 5D | | 5E | |
|---|---|---|---|---|---|---|---|---|---|---|
| Ingredients | (invention) | | (sugar) | | (Splenda ®) | | (saccharin) | | (aspartame) | |
| butter | 100 | g | 100 | g | 100 | g | 100 | g | 100 | g |
| sweetener | 80 | g | 209.52 | g | 32 | g | 13.91 | g | 26.42 | g |
| eggs | 112.0 | g | 112.0 | g | 112.0 | g | 112.0 | g | 112.0 | g |
| flour | 205 | g | 205 | g | 205 | g | 205 | g | 205 | g |
| baking powder | 7.5 | g | 7.5 | g | 7.5 | g | 7.5 | g | 7.5 | g |
| salt | 3.3 | g | 3.3 | g | 3.3 | g | 3.3 | g | 3.3 | g |
| milk | 126.31 | g | 126.31 | g | 126.31 | g | 126.31 | g | 126.31 | g |
| vanilla extract | 2.71 | g | 2.71 | g | 2.71 | g | 2.71 | g | 2.71 | g |
| almond extract | 1.36 | g | 1.36 | g | 1.36 | g | 1.36 | g | 1.36 | g |
| total weight | 638.24 | | 767.76 | | 590.24 | | 572.15 | | 584.66 | |

The butter was allowed to warm to room temperature and was mixed with the sweetener until creamy. To this creamy mixture the eggs (one at a time) and pure vanilla extract were added under continuous mixing until the eggs were completely incorporated after each addition. The flour, baking powder and salt were sifted together into another vessel. The milk and vanilla and almond extracts were incorporated together and set aside. The flour mixture was then added to the creamed butter/sweetener blend alternately with the milk mixture until all was combined. This was mixed only enough to blend all ingredients well. The batter was poured into the prepared cake pan and placed into the center of the preheated oven and baked for 20-25 minutes or until a cake tester inserted into the center came out clean. The cake was allowed to rest for 10 minutes on cooling rack and then inverted onto rack to finish cooling.

The quality of the blending of the batter and resulting yellow cake was evaluated by a skilled employee of the assignee. The sweetener of the invention (5A) blended with the butter just as well as did the sugar. Saccharin (5D) did not blend as well with butter and became pasty rather than creamy. All sweeteners with the exception of saccharin measured cup for cup with sugar for ease of recipe administration. Aspartame (5E) and Splenda® sucralose sweetener (5C) both blended smooth but at a thicker consistency than that of sugar and the sweetener composition of the invention (5A), which were at a pourable consistency. The addition of eggs, milk and extracts was consistent among all variations. The cake batters made using sugar (5B) and the sweetener composition of the invention (5A) each poured well into pans unlike those made using aspartame (5E), saccharin (5D) and Splenda® sucralose sweetener (5C) all of which had to be removed with a spatula. The bake times for each of the cake batters made using non-sugar sweeteners were shortened compared to that made using sugar. The bake times for each baking mixture are set forth in the table below.

| | 5A | 5B | 5C | 5D | 5E |
|---|---|---|---|---|---|
| | (invention) | (sugar) | (Splenda ®) | (saccharin) | (aspartame) |
| bake | 22 min | 34 min | 18 min | 20 min | 20 min |
| time | | | | | |

The yellow cake made with the sweetener composition of the invention (5A) turned out the moistest and the sweetest of all varieties. The yellow cake made with saccharin (5D) had a very bitter sweet taste with very little moisture. The yellow cakes made with aspartame (5E) and Splenda® sucralose sweetener (5C) also had very little moisture. The volume and texture of the yellow cake made with the sweetener composition of the invention (5A) was very consistent with that of the cake made with sugar (5B) with a nice moist large crumb mouth feel. The cakes made with saccharin (5D), aspartame (5E) and Splenda® sucralose sweetener (5C) all had a very fine, gummy and mushy mouth feel. The sweetness of the aspartame cake (5E) dissipated with cooking while the cake made with the sweetener composition of the invention (5A) maintained its natural lasting sweetness after cooking. The cake made with the sweetener composition of the invention (5A) had a lasting sweetness and no aftertaste. The cake made with saccharin (5D) had a very bitter aftertaste and the cake made with Splenda® sucralose sweetener (5C) had a metallic aftertaste. A table summarizing properties of the yellow cake prepared in accordance with this example is set forth below.

| | 5A | 5B | 5C | 5D | 5E |
|---|---|---|---|---|---|
| | (invention) | (sugar) | (Splenda) | (saccharin) | (aspartame) |
| Texture | very fine | fine, | very fine, | very fine, | very fine, |
| | | smooth | mushy mouth | mushy mouth | mushy mouth |
| | | | feel, gummy | feel, gummy | feel, gummy |
| Flavor | cool | buttery | buttery | bitter butter | buttery vanilla |
| | buttery | vanilla | vanilla | vanilla | |
| | vanilla | | | | |
| Aroma | sweet fresh | sweet fresh | sweet fresh | sweet fresh | sweet fresh |
| | smell | smell | smell | smell | smell |
| Moisture | 8 | 7 | 2 | 2 | 2 |
| (scale 1-10) | | | | | |
| Volume | 30% LTS | full | 40% LTS | 40% LTS | 40% LTS |
| (LTS = less | | | | | |
| than sugar) | | | | | |
| Appearance | pale yellow | nice golden | whiter in | pale yellow | pale yellow |
| | inside & | outside, no | color on | inside & | inside & |
| | outside, | cracks, pale | surface, | outside, larger | outside, larger |
| | larger | yellow | cracks, very | cracks on | cracks on |
| | cracks on | inside | smooth | surface | surface |
| | surface | | | | |
| Sweetness | 8 | 7 | 6 | 9 | 2 |
| (scale 1-10) | | | | bittersweet | |
| Aftertaste | N | N | Y | Y | N |
| | lasting | | metallic | bitter | |
| | sweetness | | | | |

Prebake batter or dough:

| | | | | | |
|---|---|---|---|---|---|
| Weight | 638.24 | 767.76 | 590.24 | 572.15 | 584.66 |
| Density | smooth, | creamy | smooth, | smooth, | smooth, |
| | slightly | smooth, | thicker not as | thicker pasty | thicker not as |
| | pourable | pourable | pourable | | pourable |

Post bake cookie or cake:

| | | | | | |
|---|---|---|---|---|---|
| Weight | 536.32 g | 691.72 g | 532.44 g | 545.13 g | 522.76 g |
| Density | smaller air | small air | very few air | fine texture, | very few air |
| | pockets | pockets | pockets | limited air | pockets |
| | overall, | | | pockets | |
| | some large | | | | |
| Height | 40.29 mm | 50.09 mm | 34.90 mm | 36.42 mm | 34.60 mm |
| Dimensions | 9″ round | 9″ round | 9″ round | 9″ round | 9″ round |
| Recipe yield | 12 | 12 | 12 | 12 | 12 |

This example demonstrates that the sweetener composition of the invention (5A), unlike sweeteners 5C-5E, blends just like sugar to form a pourable batter just like sugar and produces a cake that has the moistness and sweetness of sugar, with no unpleasant aftertaste, as well as the moist large crumb mouth feel of a cake made using sugar.

### EXAMPLE 6

This example demonstrates the use of a no calorie sweetener composition of the invention in baking applications. Specifically, this example demonstrates the use of a sweetener composition of the invention in preparing banana bread.

A standard household wall oven was preheated to a temperature of 350° F. A loaf pan measuring 4″×8″ was then greased and floured for preparation to accept the mixed batter for the bread. Five bread batter compositions (6A-6E) were prepared using a sweetener composition of the invention consisting of 70 wt. % xylitol, 29.725 wt. % maltodextrin, and 0.275 wt. % sucralose (6A), sugar (6B), Splenda® sucralose sweetener (6C), saccharin (6D) or aspartame (6E) in combination with the ingredients and amounts thereof set forth in the table below.

| | 6A | | 6B | | 6C | | 6D | | 6E | |
|---|---|---|---|---|---|---|---|---|---|---|
| Ingredients | (invention) | | (sugar) | | (Splenda ®) | | (saccharin) | | (aspartame) | |
| butter | 100 | g | 100 | g | 100 | g | 100 | g | 100 | g |
| sweetener | 80 | g | 209.52 | g | 32 | g | 30.4 | g | 26.42 | g |
| eggs | 112.06 | g | 112.06 | g | 112.06 | g | 112.06 | g | 112.06 | g |
| pure vanilla extract | 5.43 | g | 5.43 | g | 5.43 | g | 5.43 | g | 5.43 | g |
| flour | 187.5 | g | 187.5 | g | 187.5 | g | 187.5 | g | 187.5 | g |
| baking soda | 5 | g | 5 | g | 5 | g | 5 | g | 5 | g |
| salt | 20 | g | 20 | g | 20 | g | 20 | g | 20 | g |
| mashed ripe bananas | 225 | g | 225 | g | 225 | g | 225 | g | 225 | g |
| sour cream | 120 | g | 120 | g | 120 | g | 120 | g | 120 | g |
| vanilla extract | 5.43 | g | 5.43 | g | 5.43 | g | 5.43 | g | 5.43 | g |
| total weight | 860.42 | g | 989.94 | g | 812.42 | g | 810.82 | g | 806.84 | g |

The butter was allowed to warm to room temperature and was mixed with the sweetener (i.e., the sweetener composition of the invention (6A), sugar (6B), Splenda® sucralose sweetener (6C), saccharin (6D) or aspartame (6E)) until creamy. To this creamy mixture the eggs (one at a time) were added under continuous mixing until the eggs were completely incorporated after each addition. The flour, baking powder and salt were sifted together into another vessel. The flour mixture was then added to the creamed butter/sweetener blend, followed by the mashed fresh ripe banana, sour cream, and pure vanilla extract. The mixture was mixed enough to blend all ingredients well. The batter was poured into the prepared loaf pan, placed into the center of the preheated oven and baked for 60 minutes or until a cake tester inserted into the center came out clean.

The quality of the blending of the batter and resulting banana bread was evaluated by a skilled employee of the assignee. The bulk sweetener of the invention (6A) blended with the butter just as well as did the sugar (6B). Saccharin (6D) did not blend as well and became pasty rather than creamy. All sweeteners with the exception of saccharin (6D) measured cup for cup with sugar for ease of recipe administration. Batters containing aspartame (6E) and Splenda® sucralose sweetener (6C) both blended smooth but at a thicker consistency than that of sugar (6B) and the bulk sweetener composition of the invention (6A), which were at a pourable consistency. The addition of eggs was consistent among all variations. Batters made using sugar (6B) and the bulk sweetener composition of the invention (6A) each poured well into pans unlike those prepared using aspartame (6E), saccharin (6D) and Splenda® sucralose sweetener (6C) all of which had to be removed with a spatula. The bake times for each of the batters made using non-sugar sweeteners were shortened compared to that containing sugar. The bake times for each baking mixture are set forth in the table below.

| | 6A | 6B | 6C | 6D | 6E |
|---|---|---|---|---|---|
| | (invention) | (sugar) | (Splenda ®) | (saccharin) | (aspartame) |
| bake | 50-55 min | 65 min | 50-55 min | 50-55 min | 50-55 min |
| time | | | | | |

The rise in finished banana bread made using the bulk sweetener composition of the invention (6A) was greater by 12.5% over the bread made using Splenda® sucralose sweetener (6C), 30% over the bread made using saccharin (6D) and 15% over the bread made using aspartame (6E). The finished yield weight in the bread made from the bulk sweetener composition of the invention (6A) exceeded that of the bread made using saccharin (6D) by 16% and the bread made using Splenda® sucralose sweetener (6C) by 5%.

The banana bread made using the bulk sweetener composition of the invention (6A) maintained its sweetness and baked like the bread made with sugar to result in a higher sweetness level than the banana bread made using sugar (6B) after baking. The banana bread made using the bulk sweetener composition of the invention (6A) had a texture and volume equal to that of the banana bread made using sugar (6B). The bread made using saccharin (6D) had a bitter aftertaste and the bread made using aspartame (6E) completely lost all sweetness after baking. The bread made using Splenda® sucralose sweetener (6C) had a metallic aftertaste. The bread made using the bulk sweetener composition of the invention (6A) did not have any aftertaste. A table summarizing properties of the banana bread prepared in accordance with this example is set forth below.

| | 6A | 6B | 6C | 6D | 6E |
|---|---|---|---|---|---|
| | (invention) | (sugar) | (Splenda) | (saccharin) | (aspartame) |
| Texture | moist crumb, | crunchy top, | moist crumb, | moist crumb, | moist |
| | mild valleys | min valleys | dense, deep | dense, deep | crumb, |
| | | | valleys | valleys | dense, deep |
| | | | | | valleys |
| Flavor | nice sweet | rich banana | nice banana | nice banana, | nice banana |
| | banana | | | bittersweet | |
| Aroma | sweet banana | sweet banana | sweet banana | sweet banana | sweet |
| | | | | | banana |
| Moisture | 8 | 8 | 8 | 8 | 8 |
| Volume | 15% LTS | full | 25% LTS | 40% LTS | 20% LTS |
| (LTS = less | | | | | |
| than sugar) | | | | | |
| Appearance | medium | dark brown | low rise, light | least rise of | highest rise |
| | caramel color, | top, small | color | all, lighter in | of artificial |
| | nice rise | valleys, nice | | color | sweeteners, |
| | | rise | | | med |
| | | | | | caramel |
| | | | | | color |
| Sweetness | 9 | 7 | 8 | 9 | 0 |
| | | | | bittersweet | |
| Aftertaste | N | N | Y | Y | N |
| | | | metallic | bitter | |

Prebake batter or dough:

| | | | | | |
|---|---|---|---|---|---|
| Weight | 857.42 g | 1012.27 g | 788.58 g | 694.92 g | 809.75 g |
| Density | smooth, | smooth, | thicker | much thicker, | very lumpy, |
| | pourable | pourable | | pasty | thick |

Post bake cookie or cake:

| | | | | | |
|---|---|---|---|---|---|
| Weight | 757.20 g | 911.30 g | 714.33 g | 630.62 g | 730.92 g |
| Density | compact | compact | compact | compact | compact |
| | texture | texture | texture | texture | texture |
| Height | 48.80 mm | 59.75 mm | 42.70 mm | 34.48 mm | 41.79 mm |
| (pan end) | | | | | |
| Dimensions | 6 × 8 loaf pan | 4 × 8 loaf pan | 11 × 8 loaf pan | 10 × 8 loaf pan | 9 × 8 loaf |
| | | | | | pan |
| Recipe | 12 | 12 | 12 | 12 | 12 |
| yield | | | | | |

This example demonstrates that the sweetener composition of the invention (6A) blends just like sugar to form a pourable batter just like sugar and produces a banana bread that rises better than the other non-sugar sweeteners (6C-6E), has the volume, texture, and sweetness of the bread made using sugar and with no unpleasant aftertaste.

### EXAMPLE 7

This example demonstrates the use of a sweetener composition of the invention in baking applications. Specifically, this example demonstrates the use of a sweetener composition of the invention in preparing sugar cookies.

A standard household wall oven was preheated to a temperature of 350° F. A cookie sheet was then lightly greased. Five cookie dough compositions (7A-7E) were prepared using a sweetener composition of the invention consisting of 70 wt. % xylitol, 29.725 wt. % maltodextrin, and 0.275 wt. % sucralose (7A), sugar (7B), Splenda® sucralose sweetener (7C), saccharin (7D) or aspartame (7E) in combination with the ingredients set forth in the table below.

| | 7A | | 7B | | 7C | | 7D | | 7E | |
|---|---|---|---|---|---|---|---|---|---|---|
| Ingredients | (invention) | | (sugar) | | (Splenda ®) | | (saccharin) | | (aspartame) | |
| butter | 50 | g | 50 | g | 50 | g | 50 | g | 50 | g |
| sweetener | 40 | g | 104.76 | g | 16 | g | 15.2 | g | 13.21 | g |
| eggs | 28.02 | g | 28.02 | g | 28.02 | g | 28.02 | g | 28.02 | g |
| vanilla extract | 2.72 | g | 2.72 | g | 2.72 | g | 2.72 | g | 2.72 | g |
| flour | 93.75 | g | 93.75 | g | 93.75 | g | 93.75 | g | 93.75 | g |
| baking powder | 2.5 | g | 2.5 | g | 2.5 | g | 2.5 | g | 2.5 | g |
| salt | 1.65 | g | 1.65 | g | 1.65 | g | 1.65 | g | 1.65 | g |
| total weight | 218.64 | g | 283.4 | g | 194.64 | g | 193.84 | g | 191.85 | g |

The butter was allowed to warm to room temperature and was mixed with the sweetener (i.e., the sweetener composition of the invention (7A), sugar (7B), Splenda® sucralose sweetener (7C), saccharin (7D) or aspartame (7E)) until creamy. To this creamy mixture the eggs (one at a time) and pure vanilla extract were added under continuous mixing until the eggs were completely incorporated after each addition. The flour, baking soda and salt were sifted together into another vessel. The flour mixture was then added to the creamed butter/sweetener blend and blending until all ingredients were combined well and formed a ball. The dough was then covered and refrigerated for two hours. The dough was then removed from refrigeration and allowed to sit until soft enough to roll. The dough was rolled to a thickness of 4.69 mm and cut into 64.65 mm circles. The cut out cookies were placed on the lightly greased cookie sheet and baked for 8-10 minutes. The cookies were allowed to cool slightly on the pan and were then transferred to a cooling rack to cool completely.

The quality of the blending of the batter and resulting sugar cookies was evaluated by a skilled employee of the assignee. The sweetener composition of the invention (7A) blended with the butter just as well as the sugar blend. The recipes containing saccharin (7D), aspartame (7E) and Splenda® sucralose sweetener (7C) all formed a very dry cookie dough ball that did not blend as well and became pasty (sticky) rather than creamy. All sweeteners with the exception of saccharin (7D) measured cup for cup for ease of recipe administration. The finished yield of the cookies containing the sweetener composition of the invention (7A) was greater by 12% over the cookies containing Splenda® sucralose sweetener (7C), greater by 18% over the cookies containing saccharin sweetener (7D) and greater by 16% over the cookies containing aspartame (7E).

The cookies made using the sweetener composition of the invention (7A) maintained their sweetness and baked like the cookies containing sugar (7B) to result in a higher sweetness level than the cookies containing sugar (7B) after baking. The cookies made using saccharin (7D) had a bitter aftertaste and the cookies made using aspartame (7E) completely lost all sweetness after baking. The cookies made using Splenda® sucralose sweetener (7C) had a metallic aftertaste. The cookies made using the sweetener composition of the invention did not have any aftertaste. The density of the cookies made using the sweetener composition of the invention (7A) was a crumbly moist, great cooling mouth feel consistency where the cookies made using aspartame (7E), saccharin (7D) and Splenda® sucralose sweetener (7C) all had a drier mouth feel that required a beverage to digest. A table summarizing properties of the sugar cookies prepared in accordance with this example is set forth below.

| | 7A | 7B | 7C | 7D | 7E |
|---|---|---|---|---|---|
| | (invention) | (sugar) | (Splenda) | (saccharin) | (aspartame) |
| Texture | flaky, soft | crunchy, | soft, flaky | soft, very | crumbly, |
| | | “snaps” | | crumbly | soft |
| Flavor | sweet buttery | sweet buttery | buttery | sour, bland | bland flour |
| | | | metallic | | taste |
| Aroma | sweet butter | sweet butter | sweet butter | sweet | sweet butter |
| | sugar | sugar | sugar | butter | sugar |
| | | | | sugar | |
| Moisture | moderate | moderate | moderate | very dry | very dry |
| Volume | full | thin | full | full | full |
| Appearance | speckles, | “flat”, golden | thicker, | thicker, | thicker, |
| | thicker, light | color | white pasty | white pasty | white pasty |
| | golden | | color | color | color |
| Sweetness | 9 | 8 | 8 | 8 | 0 |
| (1-10) | | | | | |
| Aftertaste | N | N | Y | Y | Y |

Prebake batter or dough:

| | | | | | |
|---|---|---|---|---|---|
| Weight | 218.64 g | 283.4 g | 194.64 g | 193.84 g | 191.85 g |
| (dough) | | | | | |
| Density | drier | nice | very dry | very dry, | very dry |
| | | consistency | | least | |
| | | | | volume | |
| Height | 4.69 mm | 4.69 mm | 4.69 mm | 4.69 mm | 4.69 mm |
| (each | | | | | |
| cookie) | | | | | |
| Diameter | 64.65 mm | 64.65 mm | 64.65 mm | 64.65 mm | 64.65 mm |
| (each | | | | | |
| cookie) | | | | | |

Post Bake Cookie or cake:

| | | | | | |
|---|---|---|---|---|---|
| Weight | 214.62 g | 260.90 g | 202.35 g | 195.77 g | 200.26 g |
| (finished | | | | | |
| cookies) | | | | | |
| Density | crumbly | crumbly | flaky | airy | flaky |
| Height (avg | 8.55 mm | 6.64 mm | 9.03 mm | 9.67 mm | 10.29 mm |
| 3 cookies) | | | | | |
| Diameter | 66.89 mm | 79.14 mm | 61.23 mm | 60.37 mm | 61.00 mm |
| (avg 3 | | | | | |
| cookies) | | | | | |
| Recipe | 14.25 | 17 | 12.5 | 11.75 | 12 |
| yield | | | | | |

This example demonstrates that the sweetener composition of the invention (7A) blends just like sugar to form a cookie dough ball having the consistency of a dough made using sugar. In addition, the sweetener composition of the invention (7A) can be used to make sugar cookies having the sweetness of cookies baked with sugar without an unpleasant aftertaste and having the density and crumbly moistness of cookies baked using sugar.

EXAMPLE 8

This example demonstrates the use of a sweetener composition of the invention in baking applications. Specifically, this example demonstrates the use of a sweetener composition of the invention in preparing angel food cake.

A standard household wall oven was preheated to a temperature of 350° F. A angel food cake pan was then greased and floured for preparation to accept the mixed batter for the cake. Four cake batter compositions (8A-8C) were prepared using a sweetener composition of the invention consisting of 70 wt. % xylitol, 29.725 wt. % maltodextrin, and 0.275 wt. % sucralose (8A), sugar (8B), or Splenda® sucralose sweetener (8C) in combination with the ingredients and amounts thereof set forth in the table below.

| | 8A | | 8B | | 8C | |
|---|---|---|---|---|---|---|
| Ingredients | (invention) | | (sugar) | | (Splenda ®) | |
| egg whites | 404.80 | g | 404.80 | g | 404.80 | g |
| sweetener | 120 | g | 314.28 | g | 48 | g |
| cake flour | 136.67 | g | 136.67 | g | 136.67 | g |
| cream of tartar | 5 | g | 5 | g | 5 | g |
| salt | 2 | g | 2 | g | 2 | g |
| pure vanilla extract | 10.86 | g | 10.86 | g | 10.86 | g |
| almond extract | 2.72 | g | 2.72 | g | 2.72 | g |
| total weight | 682.05 | g | 876.33 | g | 610.05 | g |

The cake flour was sifted prior to measuring and to this was added ¾ cup of sweetener (i.e., the sweetener composition of the invention (8A), sugar (8B), or Splenda® sucralose sweetener (8C). The egg whites were allowed to achieve room temperature and then beaten until frothy at which time the cream of tartar and salt were added and beaten until fully incorporated. The sweetener (i.e., the sweetener composition of the invention (8A), sugar (8B), or Splenda® sucralose sweetener (8C)) was then added to the egg mixture 1-2 tablespoons at a time until ¾ cup was added. The egg mixture was continually beaten until soft peaks formed at which time the vanilla and almond extracts were added and combined until evenly distributed. The flour/sweetener mixture was then sifted over the egg white mixture and folded in carefully after each addition. The resulting batter was spooned into an ungreased tube pan with removable bottom and smoothed down gently with a spatula to achieve an even top surface. The pan containing the batter was gently tapped on countertop once or twice to ensure the removal of any large air pockets and was then placed in a preheated oven to bake for 40-50 minutes or until the cake top sprang back when lightly pressed. The baked cake was then removed from the oven and inverted to cool.

| | 8A | 8B | 8C |
|---|---|---|---|
| | (invention) | (sugar) | (Splenda ®) |
| cake weight (g) | 485 | 646 | 341 |
| cake height (mm) | 56.0 | 76.6 | 48.9 |

This example demonstrates that the sweetener composition of the invention (8A) can be used to make cakes having better weight and height than those made using sugar or Splenda.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-8. (canceled)

9. A no-calorie sweetener composition consisting essentially of a free flowing dry blend of about 75 to about 85 wt. % xylitol, 0.2 to 0.7 wt. % sucralose, and about 15 to about 25 wt. % agglomerated dextrose consisting of dextrose monohydrate and maltodextrin, wherein the sweetener composition has less than 0.5 calories per gram of Sucrose Equivalent Sweetness.

10. The composition of claim 9, consisting of about 78 to about 82 wt. % xylitol.

11. The composition of claim 9, consisting of 0.3 to 0.7 wt. % sucralose.

12. The composition of claim 10, consisting of 0.6 to 0.7 wt. % sucralose.

13. The composition of claim 9, consisting of about 18 to about 22 wt. % agglomerated dextrose consisting of dextrose monohydrate and maltodextrin.

14. The composition of claim 9, consisting of about 19 to about 20 wt. % agglomerated dextrose consisting of dextrose monohydrate and maltodextrin.

15. The composition of claim 9, wherein about 1.5 grams of said composition have equivalent sweetness to about 2 teaspoons of sugar.

16. A no-calorie sweetener composition consisting essentially of a free flowing dry blend of about 80 wt. % xylitol, about 0.65 wt. % sucralose, and about 19.35 wt. % agglomerated dextrose consisting of dextrose monohydrate and maltodextrin.

17. The composition of claim 9, wherein the agglomerated dextrose consists of about 97 wt. % dextrose monohydrate and about 3 wt. % maltodextrin.

18. The composition of claim 10, wherein the agglomerated dextrose consists of about 97 wt. % dextrose monohydrate and about 3 wt. % maltodextrin.

19. The composition of claim 12, wherein the agglomerated dextrose consists of about 97 wt. % dextrose monohydrate and about 3 wt. % maltodextrin.

20. The composition of claim 16, wherein the agglomerated dextrose consists of about 97 wt. % dextrose monohydrate and about 3 wt. % maltodextrin.

21. The composition of claim 16, wherein the sweeter composition has less than 0.5 calories per gram of Sucrose Equivalent Sweetness.

22. A no-calorie sweetener composition consisting essentially of a free flowing dry blend of 75 to 85.7 wt. % xylitol, 0.2 to 0.7 wt. % sucralose, 13.7% to 24.3% wt. % dextrose monohydrate, and 0.42% to 0.75% wt. % maltodextrin, wherein the dextrose monohydrate and maltodextrin are present agglomerated together, and the sweetener composition has less than 0.5 calories per gram of Sucrose Equivalent Sweetness.

23. The composition of claim 22, consisting of 80 wt. % xylitol.

24. The composition of claim 23, consisting of 0.69 wt. % sucralose.

25. The composition of claim 24, consisting of 18.7 wt. % dextrose monohydrate and 0.6% of maltodextrin.

26. The composition of claim 22, wherein about 1.5 grams of said composition have equivalent sweetness to about 2 teaspoons of sugar.
